(19) United States
(12) Patent Application Publication
(10) Pub. No.: US 2025/0236132 A1
(43) Pub. Date: Jul. 24, 2025

(54) MOLDING PROCESS FOR EMBOSSING AND MANUFACTURING LEAF-BASED TABLEWARE

(71) Applicant: David Elvenia, La Jolla, CA (US)

(72) Inventor: David Elvenia, La Jolla, CA (US)

(21) Appl. No.: 19/088,726

(22) Filed: Mar. 24, 2025

Related U.S. Application Data
(60) Provisional application No. 63/623,699, filed on Jan. 22, 2024.

(51) Int. Cl. B44D 5/00; A47G 21/00

(52) U.S. Cl. CPC B44D 5/00; A47G 21/00

(57) ABSTRACT

An eco-friendly and disposable leaf-based tableware with custom embossed patterns, such as logos, branding, designs, and the like. The leaf-based tableware is made from a mold combined with a die, wherein the die has an engraved pattern. The die can be interchangeably mounted to the mold for different patterns. The mold can be used with palm leaves for making the tableware.

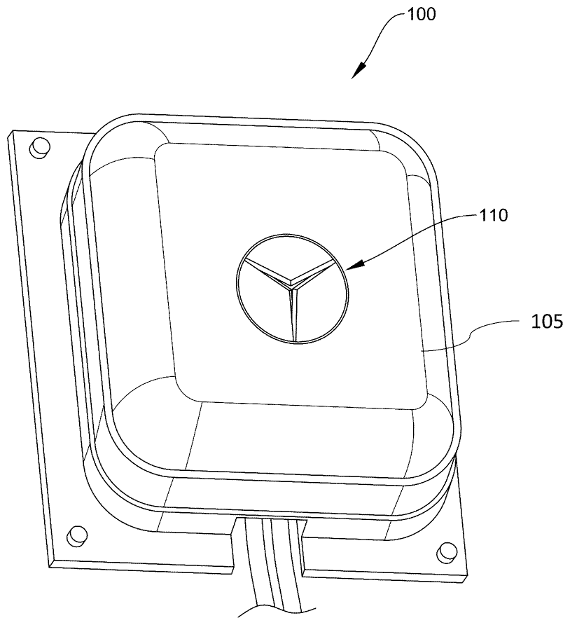

### CROSS-REFERENCE TO RELATED APPLICATIONS

This application claims priority from a U.S. Provisional Patent Appl. No. 63/623,699, filed on Jan. 22, 2024, which is incorporated herein by reference in its entirety.

### FIELD OF INVENTION

The present invention relates to the molding process for embossed, custom-branded, disposable, and biodegradable leaf-based tableware.

### BACKGROUND

Disposable tableware is quite popular and extensively used. The disposable tableware is extensively used in corporate events, outdoor events, parties, get-togethers, and takeaways. The disposable tableware is mainly made from plastic or foam material. Such disposable tableware made from plastic is difficult to dispose of and ends up in landfills. Plastic tableware either takes centuries to degrade in landfill sites or involves a complex recycling process. Both aspects of disposing of plastic disposable tableware are hazardous to the environment.

Some environmentally friendly alternatives to plastic disposable tableware are known, such as coating paper. However, such alternatives also suffer from many drawbacks. These alternatives are not completely biodegradable and take a lot of time to degrade. Recycling is also a long, costly, and environmentally unfriendly process.

Leaf-based products are emerging as a better alternative due to biodegradability and sustainability. Besides, leaf-based products have many advantages, the use of leaf-based tableware has not gained popularity due to various factors, such as lower aesthetic appeal. A need is therefore appreciated for a process to popularize the use of leaf-based tableware without significantly increasing the cost of manufacturing.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a molding and custom embossing process for leaf-based tableware.

Another object of the present invention is that the tableware can quickly and naturally biodegrade.

Another object of the present invention is that the embossing does not affect the durability or biodegradability of the leaf-based tableware.

Still, another object of the present invention is that the embossing and branding of the tableware has a minimum environmental impact.

A further object of the present invention is that leaf-based tableware can be used for a variety of food items including liquid and hot food products.

Still, a further object of the present invention is that the leaf-based tableware is disposable.

An additional object of the present invention is that the branded and embossed tableware has an aesthetic appearance.

### BRIEF DESCRIPTION OF THE DRAWINGS

The accompanying FIGURES, which are incorporated herein, form part of the specification and illustrate embodiments of the present invention. Together with the description, the FIGURES further explain the principles of the present invention and enable a person skilled in the relevant arts to make and use the invention.

The FIGURE shows a hot molding die used to make the disposable tableware, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The invention described pertains to a molding and custom embossing process for leaf-based tableware that are organic, biodegradable, and disposable. The molding and embossing processes are combined to fasten the manufacturing process and keep the manufacturing cost low. The embossing can be customized as and when required without any changes to the molding process. Custom patterns, designs, logos, and text can be embossed on the leaf-based tableware which may significantly help to increase the popularity of the leaf-based tableware and show the user's companies and individual commitment to eco efforts with branding. Leaf-based tableware can be made popular among corporations by branding on the leaf-based tableware.

The disclosed leaf-based tableware can be made from areca palm leaves. The inventor surprisingly found out that the tableware made from areca palm leaves offers certain advantages over other leaf products. Moreover, the leaves falling naturally to the ground can be used for making the disclosed leaf-based tableware. The palm leaves, in particular, from the areca palm plant can be heat molded and embossed to make durable and versatile leaf-based tableware.

The process of making the disclosed leaf-based tableware, which is embossed with custom markings, includes gathering the fallen palm leaves from the Areca Palm plant. The leaf that falls naturally to the ground can be gathered and used as a sustainable and biodegradable material. The collected leaves can be washed thoroughly to remove any dirt and any contaminants. The leaves can be subjected to high-pressure wash as well as hot water can be used. The cleaned and dried leaves can then be subjected to a molding process, according to an exemplary embodiment of the present invention. Following the molding process, the finished product can be subjected to a disinfection process. The disinfection may include subjecting the leaf-based tableware to UV radiation before packing meeting US standards.

Referring to the drawing which shows a hot molding die machine 100 for manufacturing the disclosed leaf-based tableware. The die can be made from suitable metals and alloys, such as aluminum, stainless steel, nickel-plated steel, copper, and the like. The metal can be melted and cast into the shape of the die. The shape of the die may correspond to the shape of the tableware to be made. This die can be fitted over a molding machine. The die can be interchangeably mounted to the machine so that different dies can be used for different tableware. The die may include custom patterns and markings, such as logos, which can be embossed into the tableware being made from the disclosed process. The die molding machine shown in the drawing may be for a plate. The die 105 may have a logo pattern 110 as shown in the drawing. The pattern to be embossed may be slightly depressed from the surface of the die or engraved as designed so that the same can be embossed over the tableware being molded from palm leaves.

In case where the pattern, such as the logo, words, or shape commands a larger area of the tableware, the pattern can be engraved into the die of the size of the plate, avoiding the removable die for smaller logos or art. Thus, the mold may have removable and reusable areas interchangeably containing a die for logos, branding, artistic works, and the like. This makes the invention economical and eco-friendly. Also, as shown in the drawing, the removable section is not limited to round shape in center, but the removable section can vary in shape and size, and may be as big as size and shape of the plate (tableware).

The dies can be coated with Anodized Aluminum, nickel-based Coating and/or Ceramic Coating.

Embossing the pattern, marking, design, and/or logo may be done with the molding process. As shown in the drawing, the mold and die are on the same surface. This includes when using a removable die. The temperature used may be in a range extending between 100° C. to 160° C. The pressure may be about 4-6 tons or more preferably about 5 tons.

Thus, disclosed is an eco-friendly, aesthetic, disposable tableware with custom patterns and markings, which supports environmental sustainability without compromising convenience. Moreover, being crafted from fallen palm leaves, there may be no requirement to harvest the living trees, thus a truly sustainable solution. This aligns with the growing demand for eco-conscious solutions, helping businesses and consumers meet their environmental goals. Moreover, the versatile and removable die of the mold allows for creating custom-branded tableware featuring logos or messages tailored to corporate initiatives, promotional strategies, and individual preferences.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A molding and embossing process for eco-friendly and leaf-based tableware, the molding and embossing process comprises:
gathering fallen palm leaves;
cleaning the fallen palm leaves; and
molding and embossing the fallen palm leaves using a mold with a die to obtain the leaf-based tableware, wherein the die has a pattern, and wherein the leaf-based tableware has the embossed pattern.

2. The method of claim 1, wherein the palm leaves are molded at a pressure of 4-6 tons and a temperature in a range of 100 to 160° C.

3. The method of claim 2, wherein the pattern is engraved on the die and is embossed over the tableware when the tableware is molded.

4. The method of claim 3, wherein the die is removably coupled to the mold.

5. The method of claim 3, wherein the pattern is a design.

6. The method of claim 3, wherein the pattern is a logo.

7. The method of claim 3, wherein the palm leaves are of areca palm plant.

8. A mold with a die for molding and embossing leaf-based tableware, wherein the mold with a die comprises:
a die with an engraved pattern; and
a mold configured to apply a pressure of 4-6 tons and a temperature of 100 to 160° C. on leaves, wherein the die is configured to be removably mounted to the mold.
